(19) United States
(12) Patent Application Publication
(10) Pub. No.: US 2015/0268588 A1
(43) Pub. Date: Sep. 24, 2015

(54) SUPPLY MEMBER AND IMAGE FORMING APPARATUS

(71) Applicant: FUJI XEROX CO., LTD., Tokyo (JP)

(72) Inventor: Shigeki WASHINO, Kanagawa (JP)

(21) Appl. No.: 14/492,707

(22) Filed: Sep. 22, 2014

(30) Foreign Application Priority Data
Mar. 19, 2014 (JP) 2014-056585

(51) Int. Cl. G03G 15/10

(52) U.S. Cl. CPC G03G 15/10

(57) ABSTRACT

A supply member that supplies an ink to a developing portion performing developing while being rotated, includes a plurality of concave portions that are formed on an outer circumferential surface and are randomly arranged so that an interval between one concave portion and a concave portion nest to the foregoing one concave portion on one side and an interval between the foregoing one concave portion and a concave portion next to the foregoing one concave portion on the other side are different from each other.

### CROSS-REFERENCE TO RELATED APPLICATIONS

This application is based on and claims priority under 35 USC 119 from Japanese Patent Application No., 2014-056585 filed Mar. 19, 2014.

### BACKGROUND

### Technical Field

The present invention relates to a supply member and an image forming apparatus.

### SUMMARY

According to an aspect of the invention, there is provided a supply member that supplies an ink to a developing portion performing developing while being rotated, including:

a plurality of concave portions that are formed on an outer circumferential surface and are randomly arranged so that an interval between one concave portion and a concave portion next to the foregoing one concave portion on one side and an interval between the foregoing one concave portion and a concave portion next to the foregoing one concave portion on the other side are different from each other.

### BRIEF DESCRIPTION OF THE DRAWINGS

Exemplary embodiments of the present invention will be described in detail based on the following figures, wherein;

FIG. 1 is a diagram schematically illustrating a configuration of an image forming apparatus according to an exemplary embodiment;

FIG. 2 is a diagram schematically illustrating a configuration of a developing device according to the exemplary embodiment;

FIG. 3 is a perspective view of a supply roller according to the exemplary embodiment;

FIG. 4 is a schematic diagram of plural concave portions of the supply roller according to the exemplary embodiment;

FIG. 5 is an explanatory diagram for describing a random arrangement of the plural concave portions according to the exemplary embodiment; and

FIGS. 6A, 6B, and 6C are schematic diagrams illustrating concave portions of supply rollers of comparative examples.

### DETAILED DESCRIPTION

An example of supply member and an example of image forming apparatus according to an exemplary embodiment will be described.

### Overall Configuration

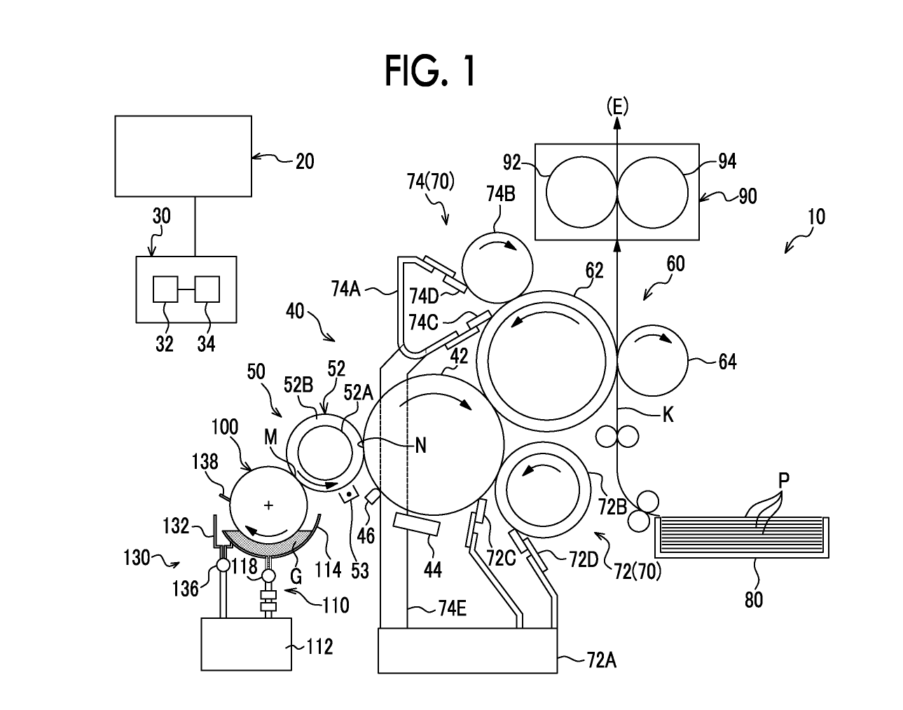

FIG. 1 illustrates an image forming apparatus 10 of this exemplary embodiment. The image forming apparatus 10 has, for example, a controller 20 which controls operations of the respective sections of the image forming apparatus 10, an image processor 30 which performs an image process to be described later, an image forming section 40 which forms an image, and a supply roller 100 as an example of a supply member to be described later. The image forming apparatus 10 further has a developer supply section 110 which supplies a liquid developer G as an example of ink to the supply roller 100 and a collection section 130 which collects the liquid developer G.

### Controller

The controller 20 has, for example, a microcomputer including a central processing unit (CPU), a random access memory (RAM), a read only memory (ROM), a nonvolatile storage medium (HDD: hard disk drive), and the like (all not shown). In the controller 20, a program for execution of from a charging process to a fixing process by the image forming section 40 to be described later is stored in the nonvolatile storage medium.

Furthermore, in the controller 20, the RAM is used as a work memory. In the controller 20, the CPU executes a program read from the nonvolatile storage medium and deployed in the RAM in order to allow the image forming section 40 to be described later to execute an image forming process on a sheet P based on image information (image data) subjected to the image process in the image processor 30. In the controller 20, a tone correction program for allowing the CPU to function as a tone correction section 32 of the image processor 30, a screen processing program for allowing the CPU to function as a screen processing section 34, and the like are stored in the nonvolatile storage medium.

### Image Processor

For example, image data in units of pages in which tones (256 tones from 0 to 255) are expressed in plural bits (for example, 8 bits) per pixel used in the image forming apparatus 10 is input to the image processor 30.

The image processor 30 has the tone correction section 32 and the screen processing section 34. The tone correction section 32 corrects tone characteristics of image data. The screen processing section 34 performs, for example, screen processing on image data in units of pages to convert multivalued data into binary data (binarization). A known configuration is applied as a basic configuration of the image processor 30. A screen pattern is a pixel array pattern, and an angle of the arrangement of pixels is a screen angle.

### Image Forming Section

As illustrated in FIG. 1, the image forming section 40 has a photoreceptor 42, a charging device 44, an exposure device 46, a developing device 30, a transfer device 60, and a cleaner 70. The developing device 50 will be described later in detail.

### Photoreceptor

For example, the photoreceptor 42 has a tubular shape and is rotatably provided so that a latent image is held on an outer circumferential surface thereof. The charging device 44, the exposure device 46, the developing device 50, the transfer device 60, and the cleaner 70 are arranged around the photoreceptor 42 from the upstream side to the downstream side in a rotation direction.

### Charging Device

The charging device 44 is opposed to the outer circumferential surface of the photoreceptor 42 with a gap therebetween on the lower side of the photoreceptor 42, and is, for example, a scorotron charging device. The charging device 44 charges the surface (outer circumferential surface) of the photoreceptor 42 by corona discharge.

### Exposure Device

The exposure device 46 is provided on the downstream side of the charging device 44 in a rotation direction of the photoreceptor 42, and is, for example, a light emitting diode (LED) exposure device. The exposure device 46 exposes the outer circumferential surface of the photoreceptor 42 charged by the charging device 44 based on image information to form a latent image on the outer circumferential surface of the photoreceptor 42. The exposure device 46 may be an exposure device other than the LED exposure device. For example, an exposure device which performs exposure using laser beams may be used.

### Transfer Device

The transfer device 60 is provided on the downstream side of the developing device 50 in the rotation direction of the photoreceptor 42. In addition, the transfer device 60 has a tubular intermediate transfer member 62 onto which the toner image formed on the outer circumferential surface of the photoreceptor 42 is transferred, and a transfer roller 64 which transfers, onto the sheet P as an example of a recording medium, the toner image transferred onto the outer circumferential surface of the intermediate transfer member 62. The transfer device 60 may have a configuration other than the above-described configuration. For example, a configuration in which a belt-like intermediate transfer member is provided, or a configuration having a direct transfer system in which the toner image is directly transferred onto the sheet P by the transfer roller 64 from the photoreceptor 42 without the intermediate transfer member may be employed.

### Cleaner

The cleaner 70 has a photoreceptor cleaner 72 which removes a liquid developer G from the photoreceptor 42, and an intermediate transfer member cleaner 74 which removes a liquid developer G from the intermediate transfer member 62.

The photoreceptor cleaner 72 has a first waste toner tank 72A, a cleaning roller 72B which is brought into contact with the outer circumferential surface of the photoreceptor 42 on the upstream side of the charging device 44 in the rotation direction of the photoreceptor 42, and cleaning blades 72C and 72D made of a urethane rubber. The cleaning blades 72C and 72D are brought into contact with the photoreceptor 42 and the cleaning roller 72B, respectively, to remove the liquid developer G remaining on the outer circumferential surface of the photoreceptor 42 after transfer. The removed liquid developer G is collected by the first waste toner tank 72A.

The intermediate transfer member cleaner 74 has a second waste toner tank 74A, a cleaning roller 74B which is brought into contact with the outer circumferential surface of the intermediate transfer member 62, and cleaning blades 74C and 74D made of a urethane rubber. The cleaning blades 74C and 74D are brought into contact with the intermediate transfer member 62 and the cleaning roller 74B, respectively, to remove the liquid developer G. The removed liquid developer G is collected by the second waste toner tank 74A. The liquid developer G collected by the second waste toner tank 74A is sent to the first waste toner tank 72A via a pipe 74E.

The cleaning roller 72B for the photoreceptor 42 and the cleaning roller 74B for the intermediate transfer member are, for example, roller members provided by coating a surface of a core made of SUS with a rubber such as an acrylonitrile butadiene rubber or an epichlorohydrin rubber. The cleaning roller 74B may be made of a metal such as aluminum, iron, or stainless steel (SUS). At this time, the surface of the roller is subjected to plating to improve smoothness and wear resistance.

In addition, the image forming apparatus 10 has an accommodating section 80 which accommodates the sheet P, and feeds the sheet P along a feeding path K. The image forming apparatus 10 further has a fixing device 90 which fixes the toner image to the sheet P onto which the toner image to be described later is transferred. As a fixing system in the fixing device 90, for example, contact-type neat fixing using a fixing roller 92 and a pressing roller 94 is used, but contact-type heat fixing using a fixing roller or belt may also be used. As the fixing system, non-contact-type heat fixing using an oven, a flash lamp, or the like may be used.

### Developing Device

Next, the developing device 50 will be described.

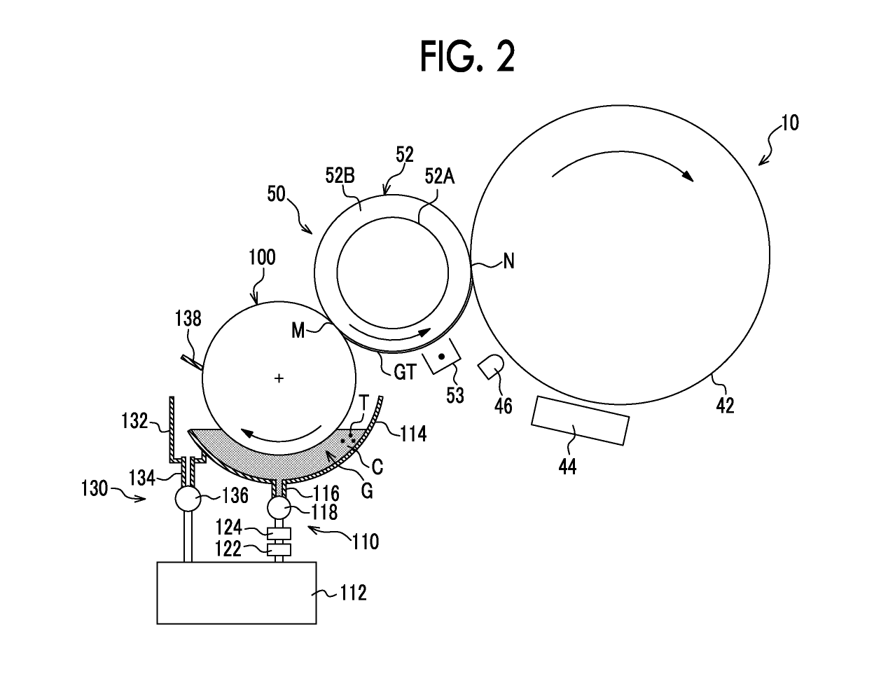

As illustrated in FIG. 2, the developing device 50 is provided on the downstream side of the exposure device 46 and on the upstream side of the intermediate transfer member 62 in the rotation direction of the photoreceptor 42. The developing device 50 develops (developing) the latent image formed on the photoreceptor 42 with a liquid developer G to be described later to form a toner image (developer image) on the outer circumferential surface of the photoreceptor 42. In addition, the developing device 50 has a developing roller 52 which holds the liquid developer G on an outer circumferential surface thereof.

In the liquid developer G, for example, a toner T (particles) is dispersed in a carrier liquid C. As the carrier liquid C, an insulating liquid such as a vegetable oil, a liquid paraffin oil, or a silicone oil is used. In this exemplary embodiment, for example, a silicone oil is used. For example, a toner containing a polyester resin is used as the toner T.

Furthermore, in the liquid developer G, for example, the toner T (particles) has an average particle diameter of 0.5 μm to 5 μm, and the toner T (particles) is dispersed at a concentration of 15 wt % to 35 wt % in the carrier liquid C. A charge-controlling agent or a dispersant may be added to the liquid developer G. The viscosity of the liquid developer G is reduced with an increase in temperature, and is increased with a reduction in temperature.

The developing roller 52 has, for example, a semi-conductive elastic layer 52B which is provided on a surface of a cylindrical core roller 52A made of a metal and has a volume resistivity of 1×10⁵ Ω·cm to 1×10¹⁰ Ω·cm. A bias voltage is applied to the core roller 52A from a power-source (not shown).

In addition, the developing roller 52 is provided so that the supply roller 100 to be described later is brought into contact with the elastic layer 52B, and in a developing portion M which is a contact portion between the developing roller 52 and the supply roller 100, a developer layer GT of a liquid developer G is formed on the developing roller 52. Furthermore, the elastic layer 52B of the developing roller 52 is brought into contact with the photoreceptor 42 to form a developing nip portion N (developing portion), and the developer layer GT is transferred onto the photoreceptor 42 at the developing nip portion N. in the developing portion M, the supply roller 100 and the developing roller 52 are moved (rotated) in the same direction, and in the developing nip portion N, the developing roller 52 and the photoreceptor 42 are moved (rotated) in the same direction.

Around the developing roller 52 (in a range opposed to the outer circumferential surface), for example, a charging unit 53 is provided between the developing portion M and the developing nip portion N. The charging unit 53 charges a surface of the developer layer GT between the developing portion M and the developing nip portion N. In other words, the charging unit 53 charges the developer layer GT on the upstream side in a rotation direction of the developing roller 52 with respect to the photoreceptor 42. The charging unit 53 charges the developer layer GT to provide the same polarity as that of the toner T contained in the developer layer GT. The charging unit 53 is, for example, a corotron charging device which charges the developer layer GT by corona discharge.

### Developer Supply Section

As illustrated in FIG. 2, the developer supply section 110 has a storage tank 112 which stores a liquid developer G therein, a reservoir 114 which stores a liquid developer G, and a supply path 116 with which the storage tank 112 and the reservoir 114 are connected.

The storage tank 112 is supplied with, for example, a toner T (particles) and a carrier liquid C through different supplying units (not shown). A liquid developer G is generated by stirring and is stored therein.

The reservoir 114 is an arc-like container provided so that a longitudinal direction thereof is a rotation axis direction (hereinafter, referred to as an axis direction) of the supply roller 100 to be described later and a cross-section crossing the longitudinal direction has an upper opening. The reservoir 114 stores the liquid developer G supplied via the supply path 116. A lower portion of the supply roller 100 to be described later is immersed in the liquid developer G of the reservoir 114.

The supply path 116 is formed of, for example, a pipe. One end thereof is connected to the storage tank 112 and the other end is connected to the deepest portion of the reservoir 114. The supply path 116 is provided with a pump 118 to supply the liquid developer G in the storage tank 112 and in the supply path 116 to the inside of the reservoir 114. A degasifier 122 which eliminates bubbles in the liquid developer G and a toner concentration sensor 124 which detects a concentration of the toner T (particles) in the liquid developer G are provided between the storage tank 112 and the pump 118 in the supply path 116.

The pump 118 is operated based on, for example, information from a liquid level detection sensor (not shown) which detects the height of a liquid level of the liquid developer G stored in the reservoir 114. That is, when information indicating a shortage of the liquid developer G in the reservoir 114 is input from the liquid level detection sensor, the pump 118 starts the operation, and when information indicating a shortage of the liquid developer G in the reservoir 114 is not input from the liquid level detection sensor, the pump 118 stops the operation.

The degasifier 122 eliminates bubbles in the liquid developer G by, for example, allowing the liquid developer G to flow to one space provided by a partition with a gas-liquid separation membrane (not shown) and by depressurizing the other space. The degasifier 122 is provided on the upstream side of the toner concentration sensor 124 (on the side close to the storage tank 112) in a direction in which the liquid developer G flows.

The toner concentration sensor 124 is provided with, for example, a light-emitting element and a light-receiving element (not shown) to detect a toner concentration based on a light intensity of light which is emitted from the light-emitting element, transmits the liquid developer G, and is received by the light-receiving element. That is, the larger the rate at which the light is blocked, the higher the toner concentration. When the toner concentration detected by the toner concentration sensor 124 is higher than a reference concentration, the carrier liquid C is supplied to the storage tank 112, and when the toner concentration is lower than the reference concentration, the toner T (partially containing the carrier liquid C) is supplied to adjust the toner concentration of the liquid developer G.

A regulation blade 138 is provided on an outer circumferential surface of the supply roller 100 to be described later to regulate an amount of the liquid developer G on the outer circumferential surface. The regulation blade 138 is formed of, for example, a planar member provided so that a longitudinal direction thereof is the axis direction of the supply roller 100. The regulation blade 138 is opposed to the outer circumferential surface of the supply roller 100, and its end portion in a lateral direction is brought into contact with the outer circumferential surface of the supply roller 100. Accordingly, the regulation blade 138 regulates an amount of the liquid developer G on the outer circumferential surface of the supply roller 100 on the outside of the reservoir 114.

### Collection Section

As illustrated in FIG. 2, the collection section 130 has, for example, a receiver 132 which receives a liquid developer G, a collection path 134 in which a liquid developer G flows, and a pump 136 which allows a liquid developer G to flow in the collection path 134 or blocks the flow.

The receiver 132 is a portion in which a cross-section cut in a direction crossing the axis direction of the supply roller 100 has a U-shape, and is provided on the further outer side than the reservoir 114 so that the liquid developer G overflowing from the reservoir 114 flows in (falls).

The collection path 134 is formed of, for example, a pipe. One end thereof is connected to the receiver 132 and the other end is connected to the storage tank 112.

The pump 136 is operated based on, for example, information from a liquid level detection sensor (not shown) which detects the height of a liquid level of the liquid developer G stored in the receiver 132. That is, when the amount of the liquid developer G in the receiver 132 is smaller than a set amount, the pump 136 stops the operation, and when the amount of the liquid developer G in the receiver 132 is larger than the set amount, the pump 118 is operated to send the liquid developer G in the receiver 132 to the storage tank 112.

### Configuration of Major Portion

Next, the supply roller 100 will be described.

As illustrated in FIG. 2, the supply roller 100 is formed to have a cylindrical shape, and is an anilox roller which adjusts an amount of the liquid developer G which is supplied by rotation from the reservoir 114 to the developing portion M of the developing roller 52. As an example of a method of manufacturing the supply roller 100, there is a method including subjecting a surface of a metal roller to ceramic coating and performing irradiation with laser beams to cut the coating.

The supply roller 100 is rotatably provided so that the axis direction thereof is made parallel to the axis direction of the developing roller 52. A lower end portion thereof is immersed in the liquid developer G of the reservoir 114, and a portion which is not immersed in the liquid developer G is brought into contact with the developing roller 52. while being rotated, the supply roller 100 is partially immersed (the lower end portion) in the liquid developer G of the reservoir 114, and thus holds the liquid developer G on the outer circumferential surface thereof and supplies the liquid developer G to the outer circumferential surface of the developing roller 52.

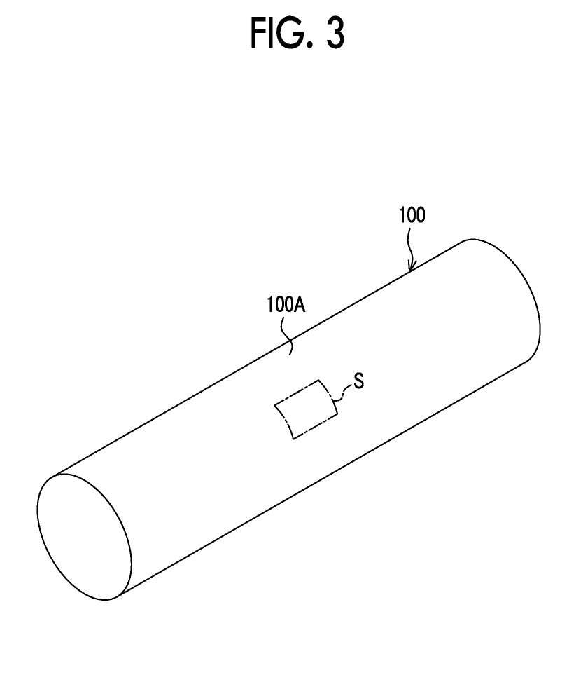

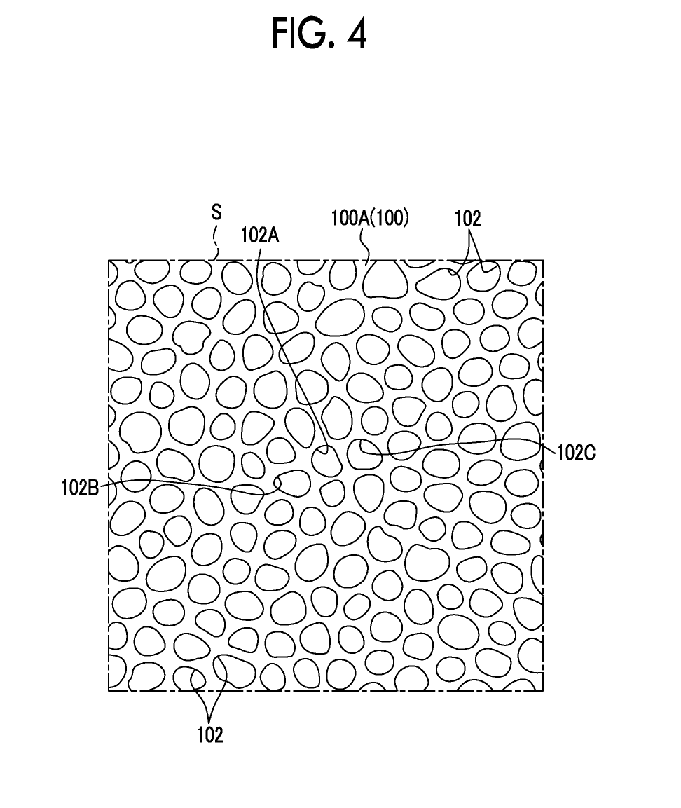

Here, FIG. 4 illustrates an enlarged view of a partial region S in the outer circumferential surface 100A of the supply roller 100 illustrated in FIG. 3. In the outer circumferential surface 100A, plural concave portions 102 having an opening on the outside in a radial direction of the supply roller 100 are formed.

The arrangement of the plural concave portions 102 in the outer circumferential surface 100A is a random arrangement to be described later. At least some concave portions 102 are arranged based on blue noise characteristics to be described later. A representative length of the plural concave portions 102 is, for example, 100 μm on average, and the liquid developer G is held in the plural concave portions 102. The plural concave portions 102 have different maximum lengths. Here, among the plural concave portions 102, three concave portions 102 next to each other are set as, for example, concave portions 102A, 102B, and 102C.

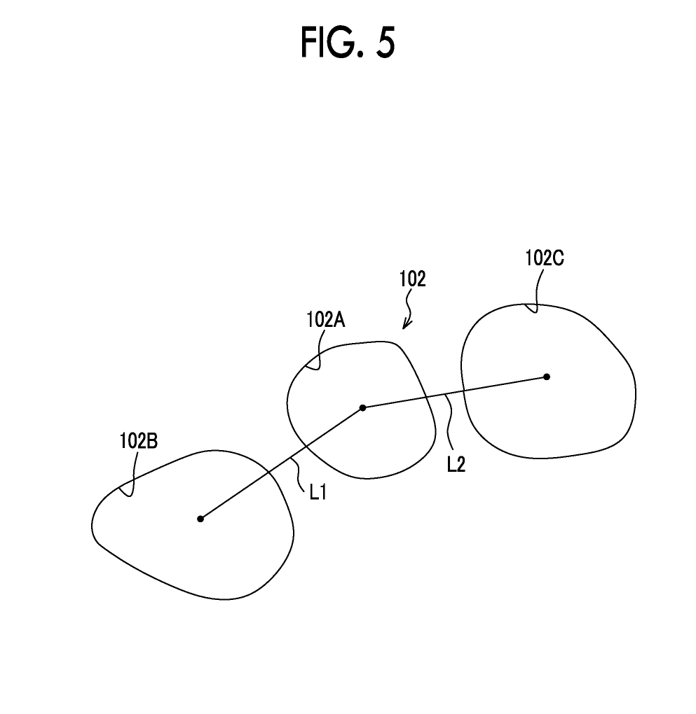

The random arrangement will be described by focusing on, for example, the three concave portions 102A, 102B, and 102C illustrated in FIG. 5. A center of the concave portion 102A is denoted by A, a center of the concave portion 102B is denoted by B, and a center of the concave portion 102C is denoted by C. A length of line segment AB (an interval between the points A and B) is denoted by L1, and a length of line segment AC (an interval between the points A and C) is denoted by L2.

Here, the random arrangement of the plural concave portions 102 means an arrangement state in which the interval L1 between the concave portion 102A and the concave portion 102B next to the concave portion 102A on one side and the interval L2 between the concave portion 102A and the concave portion 102C next to the concave portion 102A on the other side are different from each other.

In this exemplary embodiment, the blue noise characteristics mean that although intervals between the plural concave portions 102 (from one center to the other center) are randomly different from each other, the different intervals are within a set range. As for the blue noise characteristics, when spatial frequencies of the plural concave portions 102 are analysed, a peak is shown midway in a one-dimensional frequency analysis, and a donut-like swell is shown in a two-dimensional frequency analysis. As for the frequency analysis, the two-dimensional frequency analysis is performed to perform two-dimensional Fourier transformation on a photograph of the surface or the pattern of the concave portions of the outer circumferential surface 100A of the supply roller 100 with a frequency of 0 as an origin, an X-direction frequency (unit: cycle/mm) as a horizontal axis, and a Y-direction frequency (unit: cycle/mm) as a vertical axis, and the one-dimensional frequency analysis is performed to take an average value in the circumferential direction with a frequency of 0 as an origin.

As described above, the random state is a state in which the intervals between the plural concave portions 102 are different from each other, and the state of the blue noise characteristics is a state in which the intervals between the plural concave portions 102 are different from each other and are within a set range. The interval is preferably 50 microns to 200 microns, and especially preferably 80 microns to 170 microns. It is not preferable that the interval be too narrow since the liquid developer causes clogging in the concave portion 102, and it is not preferable that the interval be too wide since the pattern of the concave portions is visually recognized on a printing surface. Particularly, in the case of an image forming apparatus using liquid developing, since the toner in the developer is aggregated by being charged, the pattern of the concave portions is easily visually recognized on a printing surface.

### Image Forming Process

Next, an image forming process of the image forming apparatus 10 will be described. Each roller is rotated by a driving device (not shown) or by driven rotation in a direction shown by the arrow.

In the image forming apparatus 10 illustrated in FIG. 1, the charging device 44 charges the outer circumferential surface of the photoreceptor 42, and then the exposure device 46 (image forming section 40) forms a latent image on the outer circumferential surface of the photoreceptor 42 based on image information subjected to the above-described screen processing in the image processor 30. The latent image on the outer circumferential surface of the photoreceptor 42 is developed with the toner in the liquid charged by the charging unit 53 on the developing device 50, and thus a toner image (not shown) is formed on the outer circumferential surface of the photoreceptor 42. The toner image is an image formed (developed) with the liquid developer G supplied from the supply roller 100.

The toner image formed on the photoreceptor 42 is primarily transferred onto the outer circumferential surface of the intermediate transfer member 62 using a potential difference between the grounded photoreceptor 42 and the intermediate transfer member 62 by applying a bias voltage to a core (not shown) of the intermediate transfer member 62. The primarily transferred toner image is secondarily transferred onto the sheet P using a potential difference between the bias voltage applied to the intermediate transfer member 62 and the bias voltage applied to the transfer roller 64.

The sheet P onto which the toner image is transferred is fed to the fixing device 90 to fix the toner image (image) to the sheet P. The sheet P having the toner image fixed thereto is discharged to a discharge portion E provided at an end of the feeding path K in the image forming apparatus 10.

The liquid developer G which has not been primarily transferred onto the intermediate transfer member 62 and remains on the photoreceptor 42 is removed using the photoreceptor cleaner 72. The liquid developer G which has not been secondarily transferred onto the sheet P and remains on the intermediate transfer member 62 is removed using the intermediate transfer member cleaner 74.

### Comparative Examples

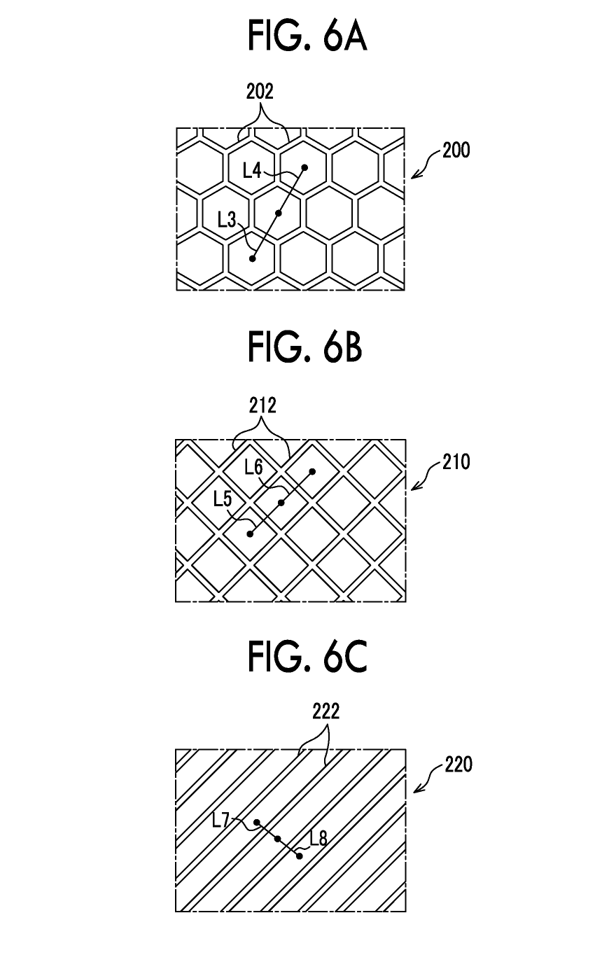

FIG. 6A illustrates an anilox roller 200 as a first comparative example. The anilox roller 200 has an outer circumferential surface having a honeycomb pattern in which plural hexagonal concave portions 202 having the same size are formed side by side in a regular manner. Specifically, in the anilox roller 200, intervals L3 and L4 connecting centers of concave portions 202 next to each other are equal to each other.

FIG. 6B illustrates an anilox roller 210 as a second comparative example. The anilox roller 210 has an outer circumferential surface having a diamond pattern in which plural square concave portions 212 having the same size are formed side by side in a regular manner. Specifically, in the anilox roller 210, intervals L5 and L8 connecting centers of concave portions 212 next to each other are equal to each other.

FIG. 6C illustrates an anilox roller 220 as a third comparative example. The anilox roller 220 has an outer circumferential surface having a helical pattern in which plural concave portions (grooves) 222 having the same size are formed side by side in a regular manner in an inclined direction. Specifically, in the anilox roller 220, intervals L7 and L8 connecting centers of concave portions 222 next to each other are equal to each other.

In the anilox rollers 200, 210, and 220 of the comparative examples, plural concave portions (or groove portions) are arranged in a regular manner. Therefore, when a liquid developer G is supplied to the developing roller 52 using any one of these rollers, interference fringes (moire) are generated in an obtained toner image due to interference of the period of the plural concave portions (irregularities) and the period of the screen in the above-described screen processing of binarizing a continuous tone image.

### Actions

Next, actions of this exemplary embodiment will be described.

In the image forming apparatus 10 illustrated in FIG. 1, the supply roller 100 is rotated to supply a liquid developer G to the developing portion M and to perform developing. Here, the plural concave portions 102 (see FIG. 4) of the supply roller 100 are randomly arranged. That is, even when the screen pattern in the above-described screen processing in the image processor 30 has periodicity, since the plural concave portions 102 of the supply roller 100 have low periodicity, the generation, of interference fringes in a toner image due to interference of the periodicities is prevented.

In the supply roller 100 of this exemplary embodiment, the plural concave portions 102 are arranged based on blue noise characteristics. Accordingly, the holding and the detachment of the liquid developer G in the concave portions 102 are more easily performed than in a case in which the sizes of the plural concave portions 102 are not managed and excessively small concave portions are formed. Thus, clogging which is caused by the liquid developer G in the concave portions 102 is prevented.

Furthermore, in the image forming apparatus 10 of this exemplary embodiment, the generation of interference fringes due to interference of the period of the screen, pattern of the image processor 30 and the period of the arrangement pattern of the plural concave portions 102 is prevented. Accordingly, image defects which are caused by the interference fringes are prevented.

Here, when an image is formed with plural colors, in the method of preventing interference fringes on the screen pattern side of the image processor 30 as a comparative example, the angle of the screen pattern needs to be changed corresponding to each color, which requires an effort.

In the formation of an image with plural colors, when the supply roller 100 ox this exemplary embodiment is used, the plural concave portions 102 are randomly arranged, and thus even when the same screen pattern is used for each color in the image processor 30, the generation of interference fringes is prevented. Therefore, an effort for changing the screen pattern is saved.

The invention is not limited to the above-described exemplary embodiments.

In the supply roller 100, a random arrangement having no blue noise characteristics may be provided. In the supply roller 100, a region corresponding to a sheet passing range of the sheet P may have blue noise characteristics.

As the random arrangement, an arrangement may be used in which the concave portions are distributed in all directions, not in a dot-like manner in the frequency analysis with a frequency of 0 as an origin, an X-direction frequency as a horizontal axis, and a Y-direction frequency as a vertical axis.

The image forming apparatus 10 is not limited to an apparatus which forms an image on the sheet P with a single color liquid developer G, and may be an apparatus which forms an image on the sheet P with plural colors of liquid developers G. For example, an image forming apparatus in which plural developing devices 50 are arranged may be used.

A gravure printer may be configured by replacing the photoreceptor 42 with a plate cylinder in the image forming apparatus 10. As an ink for gravure printing, it is possible to use, for example, an ink having the following composition; 5% to 50% of a colorant, 10% to 25% of a binder resin, 1% to 5% of an auxiliary agent, and 40% to 70% of a solvent.

The foregoing description of the exemplary embodiments of the present invention has been provided for the purposes of illustration and description. If is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A supply member that supplies an ink to a developing portion performing developing while being rotated, comprising;
a plurality of concave portions that are formed on an outer circumferential surface and are randomly arranged so that an interval between one concave portion and a concave portion next to the foregoing one concave portion on one side and an interval between the foregoing one concave portion and a concave portion next to the foregoing one concave portion on the other side are different from each other.

2. The supply member according to claim 1,
wherein as the ink, a liquid developer in which toner particles are dispersed in a carrier liquid is supplied to the developing portion.

3. The supply member according to claim 1,
wherein at least some of the concave portions are arranged based on blue noise characteristics in which intervals between the plurality of concave portions are within a set range.

4. The supply member according to claim 2,
wherein at least some of the concave portions are arranged based on blue noise characteristics in which intervals between the plurality of concave portions are within a set range.

5. The supply member according to claim 3,
wherein the intervals between the plurality of concave portions are within a range of 50 microns to 200 microns.

6. The supply member according to claim 4,
wherein the intervals between the plurality of concave portions are within a range of 50 microns to 200 microns.

7. The supply member according to claim 3,
wherein the intervals between the plurality of concave portions are within a range of 80 microns to 170 microns.

8. The supply member according to claim 4,
wherein the intervals between the plurality of concave portions are within a range of 80 microns to 170 microns.

9. An image forming apparatus comprising:
an image processor that performs screen processing to binarize image information;
the supply member according to claim 1; and
an image forming section that forms an image on a recording medium with an ink supplied from the supply member based on the image information subjected to the screen processing in the image processor.
